(19) United States
(12) Patent Application Publication
(10) Pub. No.: US 2011/0128142 A1
(43) Pub. Date: Jun. 2, 2011

(54) VEHICLE MIRROR APPARATUS AND METHOD FOR DISPLAYING TRAVELING INFORMATION

(75) Inventor: Sung Jae BYUN, Daegu (KR)

(73) Assignee: Electronics and Telecommunications Research Institute, Daejeon (KR)

(21) Appl. No.: 12/944,427

(22) Filed: Nov. 11, 2010

(30) Foreign Application Priority Data
Nov. 30, 2009 (KR) 10-2009-0116759

(51) Int. Cl. H04N 7/18; B60Q 1/34; B60R 1/10

(52) U.S. Cl. 340/475; 348/148; 362/494; 348/E07.085

(57) ABSTRACT

Provided is a vehicle minor apparatus operated in conjunction with left/right mirrors of a vehicle. The vehicle mirror apparatus may include a traveling information collection unit to detect a peripheral vehicle located in lateral and rear sides of the vehicle, and to collect traveling information corresponding to the detected peripheral vehicle, and a first display unit to display the collected traveling information using a plurality of light emitting diodes (LEDs) arranged in a matrix type.

### CROSS-REFERENCE TO RELATED APPLICATION

This application claims priority from Korean Patent Application No. 10-2009-0116759, filed on Nov. 30, 2009, in the Korean Intellectual Property Office, the entire disclosure of which is incorporated herein by reference.

### BACKGROUND

1. Field of the Invention

The present invention relates to a vehicle mirror apparatus displaying traveling information of peripheral vehicles, and a traveling information display method.

2. Description of Related Art

Currently, along with developments in information technology (IT) and electronic control technology, vehicle related technology has been becoming highly functionalized and intelligent. In order to improve safety and convenience of a driver in vehicle related fields, a Heads Up Display (HUD) system that may display information, required for vehicle traveling, on a front glass of the vehicle has been developed.

The driver may avert one's eyes from a road ahead generally for one to three seconds to check navigation or dashboard information while traveling. Accordingly, under an assumption that an average of two seconds is required for gaze shift, when a vehicle is traveled at 100 km/h, the driver has been traveling up to 50 m without actually viewing the road ahead, resulting in an increased probability of causing an accident.

In addition, the driver may perform traveling operations such as changing lanes, turning left/right, driving backwards, etc., as well as traveling straight while traveling. Accordingly, in cases of changing lanes, turning left/right, driving backward, etc., a driver's attention may need to be diverted to check peripheral vehicles located in lateral or rear sides of the vehicle. Sideward or backwards movement of the driver's attention may need a relatively longer time in comparison with checking of a navigation system or a dashboard positioned in front of the driver. Accordingly, there is a need for a study for minimizing an increase of an accident probability created due to the sideward or backward movement of the driver's attention.

### SUMMARY

According to example embodiments, a vehicle mirror apparatus and a traveling information display method may collect traveling information corresponding to peripheral vehicles located in lateral and rear sides of a vehicle of a user to display the collected traveling information on at least one of a left mirror, a right minor, and a rearview minor, thereby enabling the user to more rapidly and safely perform a traveling direction movement.

According to an aspect of the present invention, there is provided a vehicle mirror apparatus operated in conjunction with left/right mirrors of a vehicle, the vehicle mirror apparatus including: a traveling information collection unit to detect a peripheral vehicle located in lateral and rear sides of the vehicle, and to collect traveling information corresponding to the detected peripheral vehicle; and a first display unit to display the collected traveling information using a plurality of light emitting diodes (LEDs) arranged in a matrix type.

According to another aspect of the present invention, there is provided a method of displaying traveling information, including: detecting a peripheral vehicle located in lateral and rear sides of a vehicle to collect traveling information corresponding to the detected peripheral vehicle; and displaying the collected traveling information on left/right mirrors of the vehicle.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a vehicle including a vehicle minor apparatus mounted therein according to example embodiments;

FIG. 2 is a block diagram illustrating a configuration of a vehicle mirror apparatus according to example embodiments;

FIGS. 3 and 4 are diagrams illustrating examples of displaying traveling information of a vehicle mirror apparatus according to example embodiments;

FIGS. 5 and 6 are diagrams illustrating examples of displaying traveling information of a vehicle mirror apparatus according to other example embodiments; and

FIG. 7 is a flowchart illustrating a method of displaying traveling information of a vehicle mirror apparatus according to example embodiments.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

When detailed descriptions related to a well-known related function or configuration are determined to make the spirits of the present invention ambiguous, the detailed descriptions will be omitted herein. Also, terms used throughout the present specification are used to appropriately describe exemplary embodiments of the present invention, and thus may be different depending upon a user and an operator's intention, or practices of application fields of the present invention. Therefore, the terms must be defined based on descriptions made through the present invention.

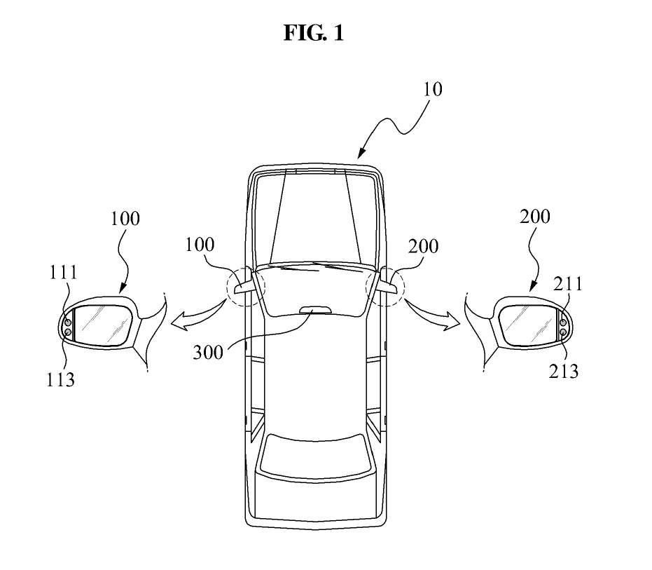

FIG. 1 is a diagram illustrating a vehicle including a vehicle mirror apparatus mounted therein according to example embodiments. The vehicle minor apparatus of FIG. 1 may be mounted in a vehicle 10, and includes a left minor 100 mounted on a driver seat door, a right minor 200 of a passenger seat door, and a rearview door 300 mounted between the driver seat door and the passenger seat door. The vehicle mirror apparatus may display, on the left mirror 100, the right minor 200, and the rearview mirror 300, traveling information corresponding to peripheral vehicles located in lateral and rear sides of the vehicle 10, thereby reducing a time required for checking the peripheral vehicles.

Specifically, the vehicle mirror apparatus may collect the traveling information of the peripheral vehicles, and display the collected traveling information on the right mirror 100, the right minor 200, and the rearview mirror 300. In this case, the traveling information of the peripheral vehicles may include distance information between the vehicle 10 and the peripheral vehicles and speed information of the peripheral vehicles. To collect the traveling information, camera module units 111 and 211 and laser module units 113 and 213 may be mounted on the left mirror 100 and the right mirror 200, respectively. The camera module units 111 and 211 and the laser module units 113 and 213 may collect traveling information varying depending on their mounted positions, and may perform an identical function. The function will be further described based on a representative example of the camera module unit 111 and the laser module unit 113 being mounted on the left mirror 100.

To collect the traveling information of the peripheral vehicles located in the left side and the rear side, the camera module unit 111 may photograph a traveling environment of each of the left side and the rear side of the vehicle 10 to thereby generate image data. The vehicle minor apparatus may analyze the generated image data, and detect vehicles included in the generated image data. The laser module unit 113 may collect the traveling information in such a manner to project a laser on the detected vehicles to detect a distance between the vehicle 10 and a corresponding vehicle and a speed of the corresponding vehicle.

As illustrated in FIG. 1, the camera module unit 111 may be preferably mounted on an outermost portion of the left mirror 100 so as to photograph the traveling environment in a wider area. Also, the laser module unit 113 may be preferably mounted on the outermost portion of the left mirror 100 so as to photograph the traveling environment of the wider area. However, mounted positions of the camera module unit 111 and the laser module unit 113 are not limited thereto, and any mounted position is possible as long as positions where the peripheral vehicles located in the lateral and rear sides of the vehicle 10 are able to be detected. For example, the camera module unit 111 and the laser module unit 113 may be mounted on a lower end of a middle portion of the left mirror 100, and mounted on an innermost portion of the left mirror 100.

In addition, the vehicle mirror apparatus may display, on the left mirror 100, the traveling information generated by the camera module unit 111 and the laser module unit 113. In this case, the traveling information displayed on the left mirror 100 may be information about a vehicle located in a left side of the vehicle 10, and may be traveling information of a vehicle closest to the vehicle 10 from among a plurality of vehicles located in the left side of the vehicle 10.

A first display unit may be attached on a rear surface of the mirror, and thus traveling information displayed by the first display unit may be displayed on the left minor 100. Alternatively, the first display unit may be mounted on a side of the left mirror 100 as a separate component.

In addition, the camera module unit 211 and the laser module unit 213 each mounted on the right mirror 200 may collect traveling information of peripheral vehicles located in a right side and the rear side of the vehicle 10. That is, the traveling information may be collected in such a manner that the camera module unit 211 photographs a traveling environment of the right side and rear side of the vehicle 10 to generate image data, and the laser module unit 213 projects a laser on a detected vehicle to thereby detect a distance between the vehicle 10 and a corresponding vehicle and a speed of the corresponding vehicle, when the corresponding vehicle is detected from the generated image data. The vehicle mirror apparatus may display, on the right minor 200, the traveling information generated by the camera module unit 211 and the laser module unit 213. In this case, the traveling information displayed on the right mirror 200 may be traveling information of a vehicle located in a right side of the vehicle 10, and may be traveling information of a vehicle closest to the vehicle 10 from among a plurality of vehicles located in a right side of the vehicle 10.

In addition, the vehicle mirror apparatus may display, on the rearview minor 300, traveling information of a vehicle located in the rear side of the vehicle 10 from among the traveling information collected by the camera module units 111 and 211 and the laser module units 113 and 213. In this case, the traveling information displayed on the rearview mirror 300 may be traveling information of a vehicle located in the rear side of the vehicle 10.

In addition, the vehicle minor apparatus may receive a traveling direction-movement signal from a main control device mounted in a main body of the vehicle 10. The main control device may transmit, to the vehicle mirror apparatus, any one of a left direction movement signal, a right direction movement signal, and a rear direction movement signal when a direction indicator provided in the left or right side of the vehicle 10 or a rear lamp of the vehicle 10 is turned on. Accordingly, the vehicle mirror apparatus may receive, as the traveling direction-movement signal, any one of the left direction movement signal, the right direction movement signal, and the rear direction movement signal.

Also, when the left direction-movement signal is received, the vehicle mirror apparatus may display traveling information on the left mirror 100, and at the same time, may determine a probability of a safe leftward movement using the traveling information. When the safe leftward movement is determined to be possible based on the distance between the vehicle 10 and the peripheral vehicle and based on the speed of the peripheral vehicle, information signifying the safe leftward movement is possible may be displayed on the left mirror 100. Specifically, when a first signal display lamp mounted on the left mirror 100 is turned on emitting a green color, the safe leftward movement may be possible.

Conversely, when the leftward movement is determined to be unsafe, information signifying the safe leftward movement is impossible may be displayed on the left mirror 100. Specifically, when a second signal display lamp mounted on the left mirror 100 is turned on emitting a red color, the leftward movement may be unsafe.

In addition, when the right direction-movement signal is received, the vehicle mirror apparatus may display traveling information on the right mirror 200, and at the same time, may determine a probability of a safe rightward movement using the traveling information. When the safe rightward movement is determined to be possible based on the distance between the vehicle 10 and the peripheral vehicle and based on the speed of the peripheral vehicle, the vehicle minor apparatus may turn on a first signal display lamp mounted on the right minor 200 emitting a green color. Conversely, when the rightward movement is determined to be unsafe, the vehicle mirror apparatus may turn on a second signal display lamp mounted on the right mirror 200 emitting a red color.

In addition, when the rear direction movement signal is received, the vehicle mirror apparatus may display traveling information on the rearview mirror, and at the same time, may determine a probability of a safe backward movement using the traveling information. When the backward movement is determined to be safe based on the distance between the vehicle 10 and the peripheral vehicle and based on the speed of the peripheral vehicle, the vehicle mirror apparatus may turn on a first signal display lamp mounted on the rearview mirror 300 emitting a green color. Conversely, when the backward movement is determined to be unsafe, the vehicle mirror apparatus may turn on a second signal display lamp mounted on the rearview mirror 300 emitting a red color.

Above, examples are described in which a probability of a safe traveling direction movement is separately displayed on the left mirror 100, the right mirror 200, and the rearview mirror 300, respectively, depending on a type of the traveling direction-movement signal, however, the probability of the safe traveling direction movement may be displayed on all of the left mirror 100, the right mirror 200, and the rearview mirror 300 regardless of the type of the traveling direction-movement signal. For example, when receiving the left direction movement signal, the vehicle mirror apparatus may determine a probability of a safe leftward movement. When the safe leftward movement is possible, the vehicle mirror apparatus may turn on each first signal display lamp mounted on the left mirror 100, the right mirror 200, and the rearview mirror 300 to display a green color, and when the safe leftward movement is impossible, the vehicle mirror apparatus may turn on each second signal display lamp mounted on the left mirror 100, the right mirror 200, and the rearview minor 300 to display a red color.

Since a driver of the vehicle 10 wishes to move leftward, the green color displayed on all of the left mirror 100, the right mirror 200, and the rearview minor 300 may be recognized as a signal signifying the safe leftward movement is possible. In this manner, by means of the green color or the red color displayed on all of the left mirror 100, the right mirror 200, and the rearview mirror 300, the driver may more rapidly determine a probability of the safe traveling direction movement, thereby reducing a time required for the driver's eyes movement leftward.

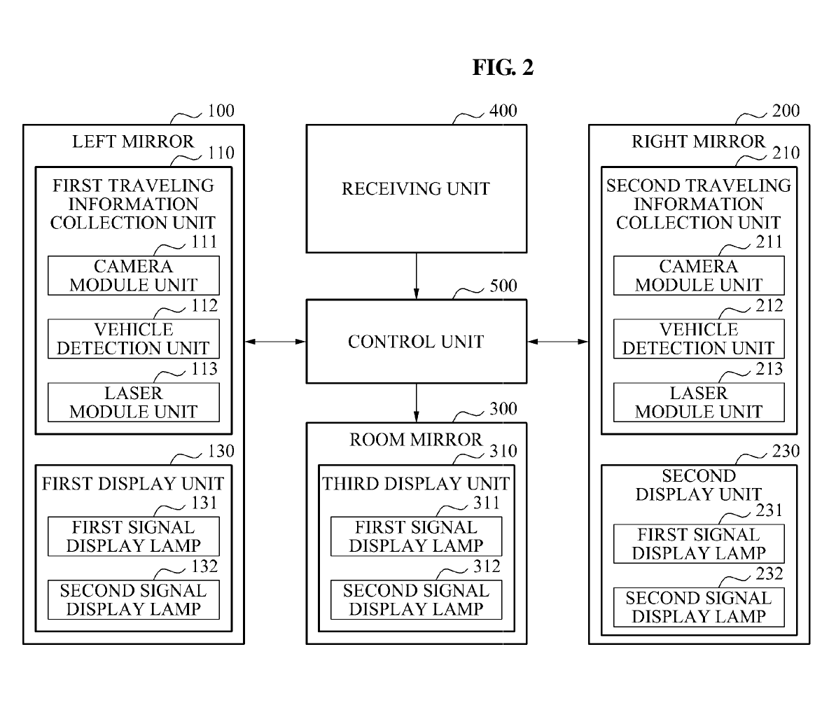

FIG. 2 is a block diagram illustrating a configuration of a vehicle mirror apparatus according to example embodiments. Referring to FIG. 2, the vehicle mirror apparatus includes the left mirror 100, the right mirror 200, the rearview mirror 300, a receiving unit 400, and a control unit 500.

The receiving unit 400 may be connected with the main control device provided on the main body of the vehicle to receive a traveling direction movement signal. Specifically, when a direction indicator mounted in the left side of the vehicle is turned on, the main control device may generate a left direction movement signal, and when a direction indicator mounted in the right side of the vehicle is turned on, the main control device may generate a right direction movement signal. Also, when a rear lamp of the vehicle is turned on, the main control device may generate a rear direction movement signal. The main control device may transmit, to the receiving unit 400, one of the left direction movement signal, the right direction movement signal, and the rear direction movement signal. In this regard, the receiving unit 400 may receive, as the traveling direction movement signal, one of the left direction movement signal, the right direction movement signal, and the rear direction movement signal.

The left minor 100 includes a first traveling information collection unit 110 and a first display unit 130.

The first traveling information collection unit 110 may detect peripheral vehicles located in left and rear sides of the vehicle 10, and collect traveling information corresponding to the detected peripheral vehicles. To collect the traveling information, the first traveling information collection unit 110 includes the camera module unit 111, a vehicle detection unit 112, and the laser module unit 113.

The camera module unit 111 may collect a traveling environment of the left and rear sides of the vehicle 10 as images to generate image data. Specifically, the camera module unit 111 may be mounted on a portion of the left mirror 100 to photograph the traveling environment of the left and rear sides of the vehicle 10.

The vehicle detection unit 112 may analyze the generated image data to detect the peripheral vehicle included in the image data. Specifically, the vehicle detection unit 112 may convert, into a binary image, the image data generated in real time, and detect a boundary from the converted binary image to detect a candidate vehicle pattern. The vehicle detection unit 112 may compare at least one predetermined criterion vehicle pattern with the detected candidate vehicle pattern, and detect, as the peripheral vehicle, a candidate vehicle pattern having a highest similarity with the criterion vehicle pattern. Here, the criterion vehicle pattern may be obtained such that commercial vehicles are photographed in various angles to form photos of the photographed vehicles as patterns.

The laser module unit 113 may project a laser on the detected peripheral vehicle to collect traveling information corresponding to the detected peripheral vehicle. In this case, the traveling information may include distance information between the vehicle 10 and the peripheral vehicle and speed information of the peripheral vehicle. For this, the laser module unit 113 may measure a distance with the peripheral vehicle and a speed of the peripheral vehicle using a time during which the laser projected on the peripheral vehicle returns back to the laser module unit 113.

The first display unit 130 may be comprised of a plurality of light emitting diodes (LEDs) for displaying the collected traveling information, and may include a first signal display lamp 131 and a second signal display lamp 132 each for displaying a probability of a safe traveling direction movement.

First, the plurality of LEDs may be arranged in a matrix type on a circuit board, and may be individually turned on/off to display the traveling information corresponding to the peripheral vehicle.

Also, the first signal display lamp 131 and the second signal display lamp 132 may be an LED lamp, each emitting a different color from each other, and may display a probability that the safe traveling direction movement to be performed is possible or impossible. Specifically, when the traveling direction movement to be performed is possible, the first signal display lamp 131 may be turned on, and when the safe traveling direction movement to be performed is impossible, the second signal display lamp 132 may be turned on. In this case, to enable a driver to more readily recognize the probability of the safe traveling direction movement, an LED lamp in which the first signal display lamp 131 emits a green color, and the second signal display lamp 132 emits a red color may be preferably adopted.

In addition, the right mirror 200 includes a second traveling information collection unit 210 and a second display unit 230.

The second traveling information collection unit 210 may detect a peripheral vehicle located in right and rear sides of the vehicle 10, and collect traveling information corresponding to the detected peripheral vehicle. To collect the traveling information, the second traveling information collection unit 210 includes the camera module unit 211, a vehicle detection unit 212, and the laser module unit 213. The camera module unit 211 may collect a traveling environment of the right and rear sides of the vehicle 10 as images to generate image data. The vehicle detection unit 212 may analyze the collected image data to detect a peripheral vehicle included in the image data. In this case, a manner in which the vehicle detection unit 212 detects the peripheral vehicle may be the same as that of the vehicle detection unit 112 included in the first traveling information collection unit 110. Also, the laser module unit 213 may project a laser on the detected peripheral vehicle to collect distance information with the peripheral vehicle and speed information of the peripheral vehicle.

The second display unit 230 may be comprised of a plurality of LEDs for displaying the traveling information, and include a first signal display lamp 231 and a second signal display lamp 232 each having a different emitting color from each other to display a probability of a safe traveling direction movement.

The rearview mirror 300 includes a third display unit 310. The third display unit 310 may be also comprised of a plurality of LEDs for displaying traveling information, and include a first signal display lamp 311 and a second signal display lamp 313 each emitting a different color from each other to display a probability of the safe traveling direction movement.

The control unit 500 may control operations of the left mirror 100, the right mirror 200, and the rearview minor 300. Specifically, when receiving a traveling direction movement signal through the receiving unit 400, the control unit 500 may control the first traveling information collection unit 110 and the second traveling information collection unit 210 to collect traveling information of the left/right and rear sides of the vehicle 10. The first traveling information collection unit 110 and the second traveling information collection unit 210 may collect the traveling information of the peripheral vehicles located in the respective locations as described above.

The control unit 500 may control the first display unit 130, the second display unit 230, and the third display unit 310 to display the traveling information collected in each of the first traveling information collection unit 110 and the second traveling information collection unit 210.

First, the control unit 500 may control the first display unit 130 to display traveling information of a peripheral vehicle located in the left side of the vehicle 10, and control the second display unit 230 to display traveling information of a peripheral vehicle located in the right side of the vehicle 10. Also, the control unit 500 may control the third display unit 310 to display traveling information of a peripheral vehicle located in the rear side of the vehicle 10. In this regard, each of the plurality of LEDs mounted in the first to third display units 130, 230, and 310 may be separately adjusted to be turned on/off.

For example, when receiving the left direction movement signal, the control unit 500 may receive traveling information from each of the first traveling information collection unit 110 and the second traveling information collection unit 210. Also, the control unit 500 may analyze the traveling information collected in the first traveling information collection unit 110, and control the first display unit 130 to display traveling information of a vehicle located closest to the left side of the vehicle 10. Also, the control unit 500 may analyze the traveling information collected in the second traveling information collection unit 210, and control the second display unit 230 to display traveling information of a vehicle located closest to the right side of the vehicle 10. Also, the control unit 500 may analyze each of the traveling information collected in the first traveling information collection unit 110 and the second traveling information collection unit 210, and control the third display unit 310 to display traveling information of a vehicle located closest to the rear side of the vehicle 10.

In this manner, the control unit 500 may display the traveling information of the peripheral vehicles on the left mirror 100, the right mirror 200, and the rearview mirror 300, and thus may enable a driver to more rapidly check the distance information with the peripheral vehicles and the speed information of the peripheral vehicles, thereby reducing a time required for adjusting of eyes.

In addition, the control unit 500 may determine a probability of a safe traveling direction movement using the traveling information collected in each of the first traveling information unit 110 and the second traveling information unit 210, and control the first to third display unit 130, 230, and 310 to display the determined result.

That is, when the safe traveling direction movement is determined to be possible, the control unit 500 may control the first signal display lamp, included in at least one of the first to third display units 120, 230, and 310, to be turned on, and when the safe traveling direction movement is determined to be impossible, the control unit 500 may control the second signal display lamp, included in at least one of the first to third display units 120, 130, and 310, to be turned on. In this manner, the control unit 500 may display, on the left minor 100, the right mirror 200, and the rearview minor 300, a probability of the safe traveling direction movement leftward, thereby enabling a driver to rapidly recognize the probability of the safe traveling direction movement.

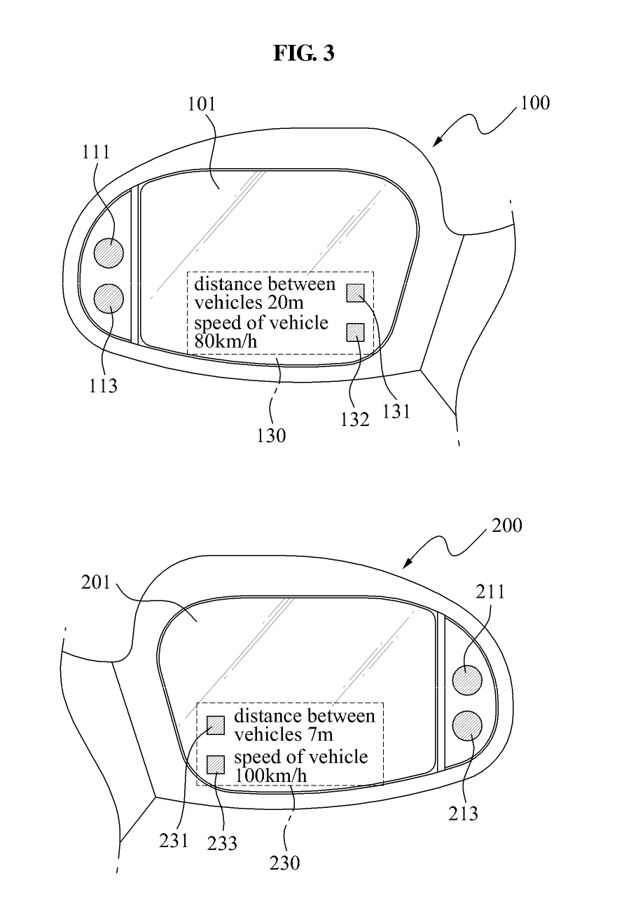

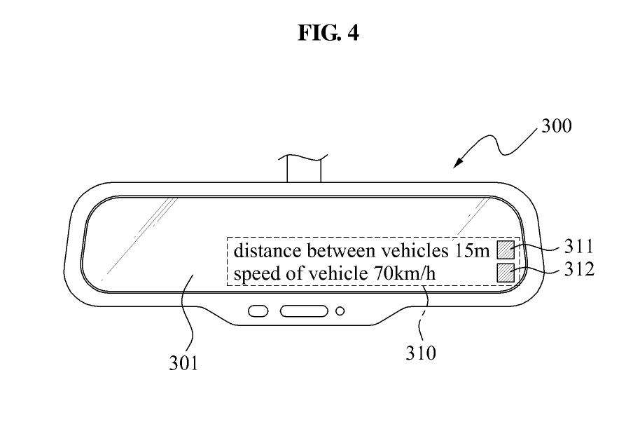

FIGS. 3 and 4 are diagrams illustrating examples of displaying traveling information of a vehicle minor apparatus according to example embodiments. Specifically, FIG. 3 shows traveling information display type of the left mirror 100 and the right mirror 200, and FIG. 4 shows traveling information display type of the rearview mirror 300. The left mirror 100 illustrated in FIG. 3 includes the camera module unit 111 and the laser module unit 113 each mounted on an outermost portion of the left mirror 100, and also includes the first display unit 130 attached on a rear surface of a mirror 101. Accordingly, traveling information displayed on the first display unit 130 may be actually viewed through a front surface of the mirror 101. The driver may verify the traveling information displayed on the mirror 101, and may recognize that a distance with a peripheral vehicle located in the left side of the vehicle 10 is 20 m, and a speed of the peripheral vehicle is 80 km/h.

In addition, the right mirror 200 may include the camera module unit 211 and a laser module unit 213 each mounted on an outermost portion, and also include the second display unit 230 attached on a rear surface of a mirror 201. Accordingly, traveling information displayed on the second display unit 230 may be actually viewed through a front surface of the mirror 201. The driver may verify the traveling information displayed on the mirror 201, and may recognize that a distance with a peripheral vehicle located in the right side of the vehicle 10 is 20 m, and a speed of the peripheral vehicle is 100 km/h.

Referring to FIG. 4, the rearview mirror 300 may include the third display unit 310 attached on a rear surface of a mirror 301, and traveling information may be actually viewed through a front surface of the mirror 301. The driver may verify the traveling information displayed on the mirror 301, and recognize that a distance with a peripheral vehicle located in the rear side of the vehicle 10 is 15 m and a speed of the peripheral vehicle is 70 km/h.

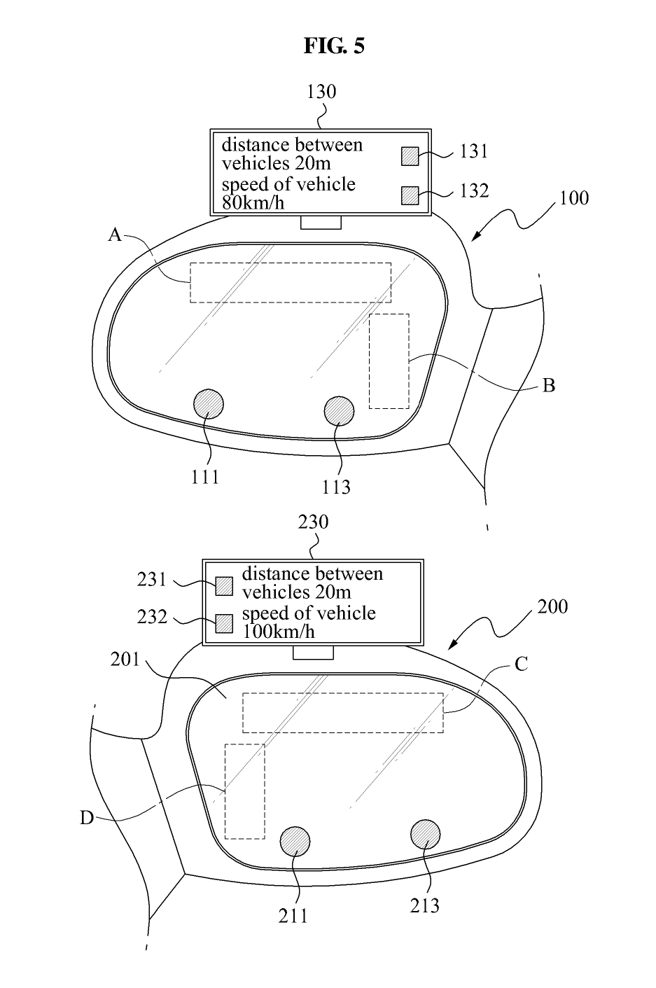

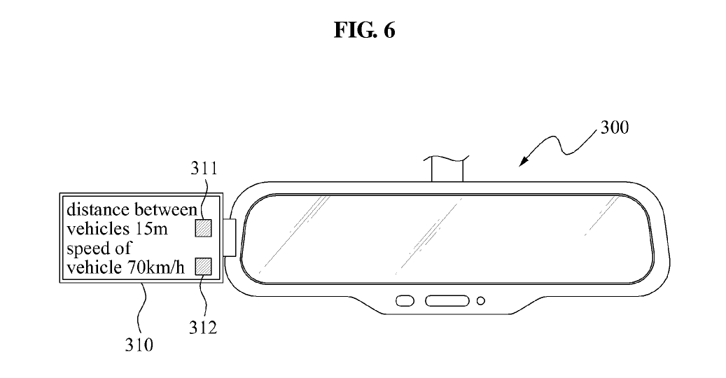

FIGS. 5 and 6 are diagrams illustrating examples of displaying traveling information of a vehicle minor apparatus according to other example embodiments. As for the left mirror 100 and the right mirror 200 illustrated in FIG. 5, mounted positions of the camera module units 111 and 211 and the laser module units 113 and 213 and a type of the first and second display units 130 and 230 may differ from those of the left mirror of the FIG. 3.

Specifically, the camera module unit 111 and the laser module unit 113 may be mounted on a lower end portion of a middle portion of the left mirror 100, respectively. Also, although not illustrated in FIGS. 5 and 6, according to another example embodiment, the camera module unit 111 and the laser module unit 113 may be mounted on an upper middle portion (A) or an innermost portion (B) of the left mirror 100, respectively.

Also, the camera module unit 211 and the laser module unit 213 may be mounted on a lower end portion of a middle portion of the right minor 200, respectively. The mounted positions of the camera module unit 211 and the laser module unit 213 may not be limited to those of FIG. 5, and may be mounted on an upper middle portion (C) or an innermost portion (D) of the right mirror 200.

In addition, the first display unit 130 and the second display unit 230 may not be attached on the rear surface of the corresponding minor, and may be mounted on any one side of each of the left and right mirror 100 and 200 as separate components. That is, as illustrated in FIG. 5, the first display unit 130 may be mounted on an upper portion of the left mirror 100 to display corresponding traveling information, and the second display unit 230 may be mounted on an upper portion of the right mirror 200 to display corresponding traveling information.

In addition, as described above, each of the camera module units 111 and 211 and the laser module units 113 and 213 may be mounted on the left mirror 100 or the right mirror 200, however, the camera module units 111 and 211 and the laser module units 113 and 213 may be mounted in such a manner as to be coupled to a side of each of the first and second display units 130 and 230 illustrated in FIG. 5.

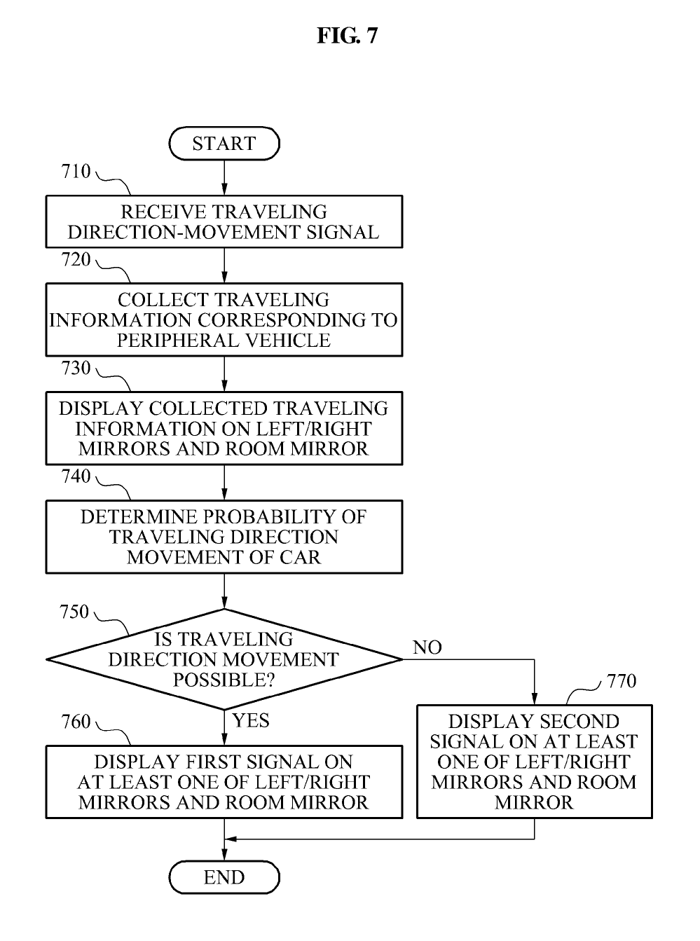

FIG. 7 is a flowchart illustrating a method of displaying traveling information of a vehicle mirror apparatus according to example embodiments. Referring to FIG. 7, the vehicle mirror apparatus may collect traveling information corresponding to peripheral vehicles in operation S720, when receiving a traveling direction movement signal in operation S710. In this case, the traveling direction movement signal may be one of a left direction movement signal, a right direction movement signal, and a rear direction movement signal. The traveling information may include a distance with peripheral vehicles located in a left side, a right side, and a rear side of the vehicle 10, and a speed of the peripheral vehicles.

Next, the vehicle minor apparatus may display the collected traveling information on the left mirror 100, the right minor 200, and the rearview minor 300, and may determine a probability of a safe traveling direction movement of a corresponding vehicle in operation S740. Specifically, when receiving a left direction movement signal from a main control device, the vehicle mirror apparatus may determine the probability of the safe traveling direction movement using traveling information of a peripheral vehicle located in the left side of the vehicle 10. For example, when a distance with the peripheral vehicle located in the left side of the vehicle 10 is 10 m, and a speed of the peripheral vehicle is 40 km/h, the vehicle mirror apparatus may determine that a safe traveling direction movement leftward is possible. When the distance with the peripheral vehicle is 1 m and the speed of the peripheral vehicle is 40 km/h, the vehicle mirror apparatus may determine that the safe traveling direction movement leftward is impossible due to a probability of a vehicle collision.

In addition, when the safe traveling direction movement is possible based on the determined result of operation S740, that is, in a case of a YES branch of operation S750, the vehicle minor apparatus may display a first signal on at least one of the left mirror 100, the right mirror 200, and the rearview mirror 300 in operation S760. In this case, the first signal may be a signal emitting a green color.

In addition, when the safe traveling direction movement is impossible based on the determined result of operation S740, that is, in a case of a NO branch of operation S750, the vehicle mirror apparatus may display a second signal on at least one of the left mirror 100, the right mirror 200, and the rearview mirror 300 in operation S770. In this case, the second signal may be a signal emitting a red color.

As described above, the vehicle minor apparatus may display traveling information of peripheral vehicles located in lateral and rear sides of a corresponding vehicle while traveling, and display a probability of a safe traveling direction movement. Accordingly, there is no need for a relatively longer time required to verify the peripheral vehicles located in the lateral and rear sides, thereby enabling a driver to more safely and conveniently change traveling direction.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A vehicle mirror apparatus operated in conjunction with left/right mirrors of a vehicle, the vehicle mirror apparatus comprising:
a traveling information collection unit to detect a peripheral vehicle located in lateral and rear sides of the vehicle, and to collect traveling information corresponding to the detected peripheral vehicle; and
a first display unit to display the collected traveling information using a plurality of light emitting diodes (LEDs) arranged in a matrix type.

2. The vehicle minor apparatus of claim 1, wherein the traveling information collection unit comprises:
a camera module unit to collect a traveling condition of the lateral and rear sides of the vehicle to generate image data;
a vehicle detection unit to analyze the generated image data to detect the peripheral vehicle included in the image data; and
a laser module unit to project a laser on the detected peripheral vehicle to collect the traveling information.

3. The vehicle mirror apparatus of claim 2, wherein the vehicle detection unit converts the generated image data into a binary image, detects a boundary from the converted binary image to detect a candidate vehicle pattern and compares at least one predetermined criterion vehicle pattern with the detected candidate vehicle pattern to detect the peripheral vehicle from the generated image data.

4. The vehicle minor apparatus of claim 1, further comprising:
a second display unit mounted on a main body of a rearview mirror of the vehicle and adopted to display the collected traveling information using the plurality of LEDs arranged in the matrix type.

5. The vehicle mirror apparatus of claim 1, wherein the display unit includes a first signal display lamp and a second signal display lamp each emitting a different color from each other.

6. The vehicle minor apparatus of claim 5, further comprising:
a receiving unit to receive a traveling direction-movement signal from a main control device of the vehicle; and
a control unit to determine a probability of a safe traveling direction movement using the traveling information when the traveling direction-movement signal is received, to control to turn on the first signal display lamp when the safe traveling direction movement is determined to be possible, and to control to turn on the second signal display lamp when the safe traveling direction movement is determined to be impossible.

7. The vehicle mirror apparatus of claim 6, wherein the traveling direction-movement signal is any one of a left direction movement signal, a right direction movement signal, and a rear direction movement signal.

8. The vehicle mirror apparatus of claim 1, wherein the display unit is mounted on the rear side of the minor.

9. The vehicle mirror apparatus of claim 1, wherein the display unit is mounted on any one of the left/right minors, respectively.

10. The vehicle minor apparatus of claim 1, wherein the traveling information includes distance information between the vehicle and the peripheral vehicle and speed information of the detected peripheral vehicle.

11. A method of displaying traveling information, comprising:
detecting a peripheral vehicle located in lateral and rear sides of a vehicle to collect traveling information corresponding to the detected peripheral vehicle; and
displaying the collected traveling information on left/right minors of the vehicle.

12. The method of claim 11, wherein the detecting comprises:
collecting, as an image, a traveling condition of the lateral and rear sides of the vehicle to generate image data;
analyzing the generated image data to detect the peripheral vehicle included in the image data; and
projecting a laser on the detected peripheral vehicle to collect the traveling information.

13. The method of claim 12, wherein the analyzing comprises:
converting the generated image data into a binary image;
detecting a boundary from the converted binary image to detect a candidate vehicle pattern; and
comparing at least one predetermined criterion vehicle pattern with the detected candidate vehicle pattern to detect the peripheral vehicle from the generated image data.

14. The method of claim 11, further comprising:
displaying the collected travel information on a rearview mirror of the vehicle.

15. The method of claim 11, further comprising:
receiving a traveling direction-movement signal from a main control device of the vehicle;
determining a probability of a safe traveling direction movement using the traveling information when the traveling direction-movement signal is received;
displaying a first signal on at least one of the left/right mirrors of the vehicle when the safe traveling direction movement is determined to be possible, and displaying a second signal on the at least one of the left/right minors of the vehicle when the safe traveling direction movement is determined to be impossible.

16. The method of claim 15, wherein the traveling direction-movement signal is any one of a left direction movement signal, a right direction movement signal, and a rear direction movement signal.

17. The method of claim 11, wherein the traveling information is distance information between the vehicle and the peripheral vehicle and speed information of the detected peripheral vehicle.
